(19) United States
(12) Patent Application Publication
(10) Pub. No.: US 2025/0061538 A1
(43) Pub. Date: Feb. 20, 2025

(54) METHOD OF ENCODING/DECODING A FEATURE MAP

(71) Applicant: Electronics and Telecommunications Research Institute, Daejeon (KR)

(72) Inventors: Youn Hee KIM, Daejeon (KR); JooYoung LEE, Daejeon (KR); Se Yoon JEONG, Daejeon (KR); Jin Soo CHOI, Daejeon (KR); Jung Won KANG, Daejeon (KR)

(21) Appl. No.: 18/805,459

(22) Filed: Aug. 14, 2024

(30) Foreign Application Priority Data
Aug. 14, 2023 (KR) 10-2023-0106404
Aug. 13, 2024 (KR) 10-2024-0108386

(51) Int. Cl. G06T 3/067; G06T 3/4046

(52) U.S. Cl. CPC G06T 3/067; G06T 3/4046

(57) ABSTRACT

A feature map encoding method according to the present disclosure may include generating a feature map from a multi-level feature group; and performing PCA (Picture Component Analysis) transform for the feature map. Here, generating the feature map comprises reshaping the multi-level feature group; and generating the feature map by merging a plurality of base units generated by the reshape.

### CROSS-REFERENCE TO RELATED APPLICATION

This application claims priority under 35 U.S.C § 119 to Korean Patent Application No. 10-2023-0106404, filed in the Korean Intellectual Property Office on Aug. 14, 2023, and Korean Patent Application No. 10-2024-0108386, filed on Aug. 13, 2024, the entire contents of which are hereby incorporated by reference.

### FIELD OF THE INVENTION

The present disclosure relates to a method of encoding/decoding a feature map and device therefor.

### DESCRIPTION OF THE RELATED ART

Traditionally, image encoding/decoding technology has improved to enhance image compression efficiency and image quality by considering the human visual system. However, in the future, image encoding/decoding technology is expected to be widely used in the fields of machine vision such as surveillance, intelligent transportation, smart city, or intelligent industry as well as human vision.

Accordingly, the development of image encoding/decoding technology that may obtain high-efficiency compression and recognition accuracy by simultaneously considering human vision and machine vision is required.

### DISCLOSURE

### Technical Problem

The present disclosure is to provide a method of encoding/decoding features extracted from an input image.

The present invention is to reduce an amount of data to be encoded/decoded by converting a multi-level feature group to a feature map.

The present invention is to reduce an amount of data to be encoded/decoded by performing PCA transform.

The technical objects to be achieved by the present disclosure are not limited to the above-described technical objects, and other technical objects which are not described herein will be clearly understood by those skilled in the pertinent art from the following description.

### Technical Solution

A feature map encoding method according to the present disclosure may include generating a feature map from a multi-level feature group; and performing PCA (Picture Component Analysis) transform for the feature map. Here, generating the feature map comprises reshaping the multi-level feature group; and generating the feature map by merging a plurality of base units generated by the reshape.

In a feature map encoding method according to the present disclosure, the reshape is based on pixel un-shuffling technique.

In a feature map encoding method according to the present disclosure, a first layer in the multi-level feature group is reshaped to a resolution of a second layer in the multi-level feature group.

In a feature map encoding method according to the present disclosure, the second layer has a smallest resolution in the multi-level feature group.

In a feature map encoding method according to the present disclosure, in response to a resolution of the first layer is N times to the resolution of the second layer, a number of channel of a reshaped first layer is N times to a number of channel of the first layer.

In a feature map encoding method according to the present disclosure, the second layer is arranged in a single tile in the feature map, and the first layer is arranged in N tiles in the feature map.

In a feature map encoding method according to the present disclosure, N pixels, in the first layer, which corresponding to a pixel at a first position in the second layer are arranged in a same column as the pixel at the first position in the feature map.

In a feature map encoding method according to the present disclosure, a first layer and a second layer in the multi-level feature group have a same number of channels but have different resolution, and each of the first layer and the second layer are reshaped by the number of channels.

In a feature map encoding method according to the present disclosure, the PCA transform is performed based on a reduced basis vector, and a number of transform coefficients generated by the PCA transform is less than a size of the feature map.

A feature map decoding method according to the present disclosure may include performing PCA (Picture Component Analysis) inverse transform for transform coefficients; and restoring a multi-level feature group from a feature map output by the PCA inverse transform. Here, restoring the multi-level feature group comprises: splitting the feature map into a plurality of channels; and restoring the multi-level feature group by merging base units per a feature layer.

In a feature map decoding method according to the present disclosure, each of the plurality of channels is obtained by arranging pixels in a single row in the feature map in a pre-defined size.

In a feature map decoding method according to the present disclosure, a feature layer in the multi-level feature group is restored by merging a plurality of channels obtained from at least one tile, in the feature map, corresponding to the feature layer.

In a feature map decoding method according to the present disclosure, in response to a number of tiles corresponding to the feature layer is plural, the feature layer is restored by arranging each of the plurality of channels into a pre-defined position according to pixel shuffling technique.

In a feature map decoding method according to the present disclosure, a size of a tile in the feature map is determined based on a size of a feature layer with the smallest resolution in the multi-level feature group.

In a feature map decoding method according to the present disclosure, in response to a number of channels is the same between a first layer and a second layer in the multi-level feature group, a size of the tile in the feature map is determined based on the number of channels.

In a feature map decoding method according to the present disclosure, in response to a resolution of the first layer is N times to a resolution of the second layer, a number of tiles corresponding to the first layer is N times to a number of tiles corresponding to the second layer.

In a feature map decoding method according to the present disclosure, the PCA inverse transform is performed by a reduced basis vector, and a size of the feature map generated by the PCA inverse transform is greater than a number of the transform coefficients.

Meanwhile, according to the present disclosure, a computer readable recording medium recording instructions for executing the feature decoding method, instructions for executing the feature encoding method or a bitstream generated by the feature encoding method may be provided.

### Advantageous Effects

According to the present disclosure, an amount of data to be encoded/decoded may be reduced by encoding/decoding features derived from an input image instead of encoding/decoding the input image.

According to the present disclosure, an amount of data to be encoded/decoded may be reduced by converting a multi-level feature group into a feature map.

According to the present disclosure, an amount of data to be encoded/decoded may be reduced by performing PCA transform.

### BRIEF DESCRIPTION OF DRAWINGS

FIG. 1 is a diagram of a machine task processing system comprising a feature encoder and a feature decoder according to an embodiment of the disclosure.

FIG. 2 is a detailed configuration diagram of the feature encoder illustrated in FIG. 1.

FIG. 3 is a detailed configuration diagram of the feature decoder illustrated in FIG. 1.

FIGS. 4 and 5 illustrate examples of generating a multi-level feature group.

FIGS. 6 and 7 are diagrams showing a configuration of a feature encoder and a feature decoder to which PCA transform/inverse transform is applied, respectively.

FIGS. 8 and 9 are block diagrams of the feature encoder and feature decoder according to one embodiment of the present disclosure, respectively.

FIG. 10 illustrates an example of rearranging features using a pixel un-shuffling technique.

FIG. 11 illustrates an arrangement method based on the number of channels.

FIG. 12 illustrates an example of a resolution-based arrangement method.

FIG. 13 shows an example of performing PCA transform using reduced basis vectors.

FIGS. 14 and 15 are flowcharts of a feature map encoding method and a feature map decoding method according to an embodiment of the present disclosure, respectively.

### DETAILED DESCRIPTION OF THE INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

FIG. 1 is a diagram of a machine task processing system comprising a feature encoder and a feature decoder according to an embodiment of the disclosure.

Referring to FIG. 1, when features are extracted from the input image based on a neural network task, the extracted features are entered into the feature encoder 100.

The feature encoder 100 encodes the input features to generate a bitstream.

When the generated bitstream is transmitted to the feature decoder 200, the feature decoder 200 may decode the received bitstream and restore the features.

Meanwhile, based on the features restored from the video decoder (200), neural network tasks may be performed.

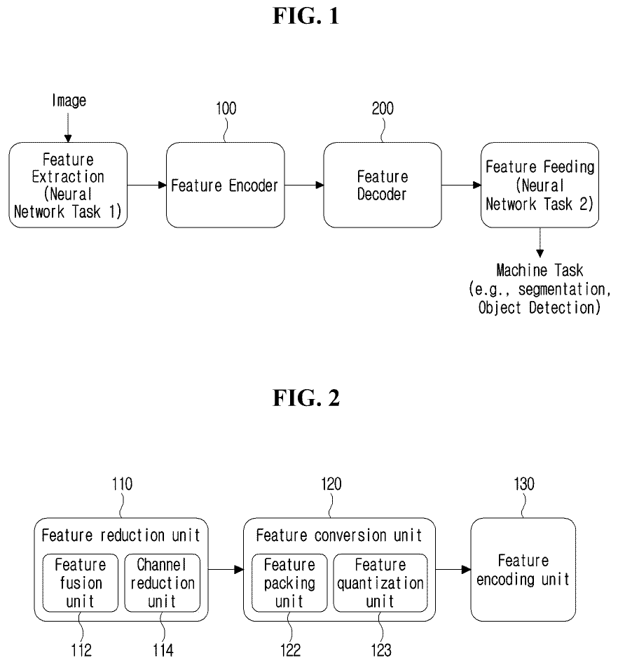

FIG. 2 is a detailed configuration diagram of the feature encoder illustrated in FIG. 1.

Referring to FIG. 2, the feature encoder (100) may include a feature reduction unit (110), a feature conversion unit (120), and a feature encoding unit (130).

The feature reduction unit (110) may perform a feature fusion and a channel reduction on an input multi-level feature group. Here, the multi-level feature group may composed of a group of features with multiple layers.

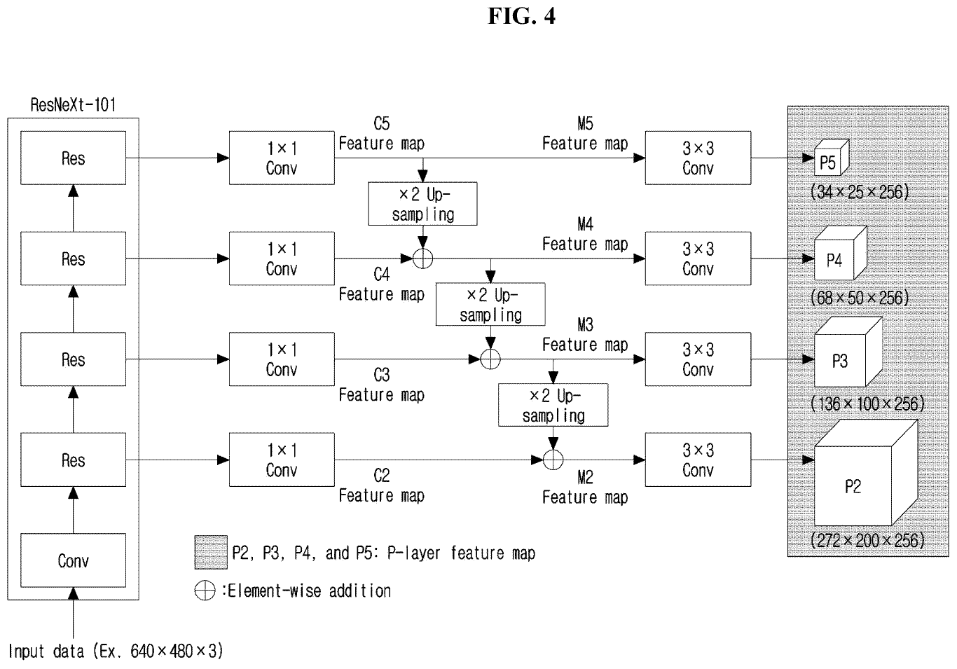

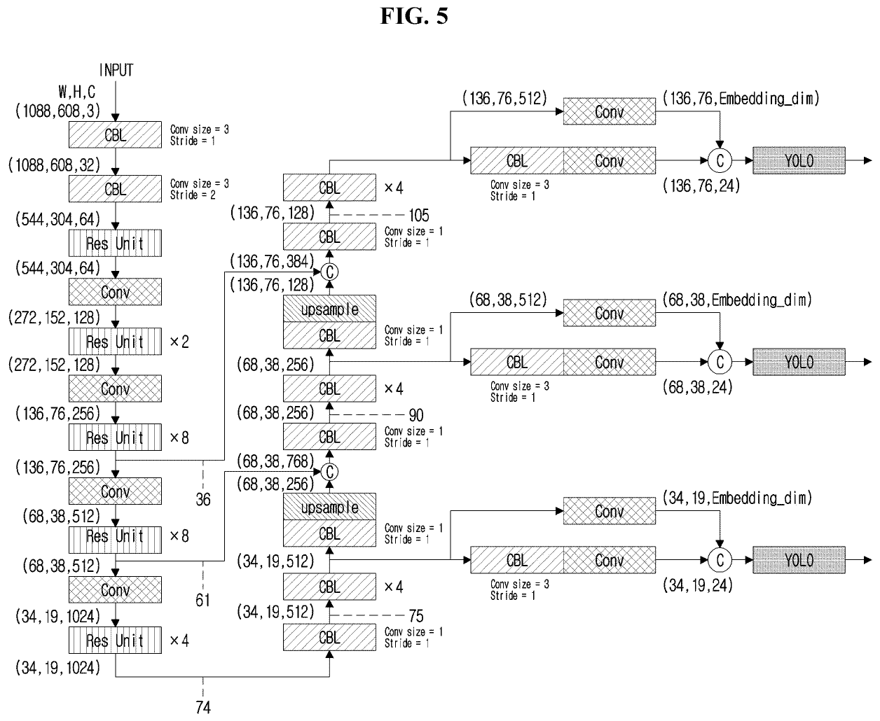

FIGS. 4 and 5 illustrate examples of generating a multi-level feature group.

An example, illustrated in FIG. 4, shows that a multi-level feature group consisting of multiple P-layers is generated through Faster/Mask R-CNN.

As in the example illustrated in FIG. 4, the PN layer may have the same number of channels as the P(N−1) layer, but the width and height may be half the size of the P(N−1) layer. For example, the P2 layer may be a group of features with a size of 272×200 consisting of 256 channels, and the P3 layer may be a group of features with a size of 136×100 consisting of 256 channels.

An example, illustrated in FIG. 5, shows that a multi-level feature group consisting of multiple layers is generated through a JDE network.

Unlike the example illustrated in FIG. 5, the multi-level feature group generated via the JDE network may include L0 to L2 layers. In this case, the LN layer may have twice the number of channels compared to the L(N−1) layer, but the width and height may be half the size of the L(N−1) layer. For example, the L0 layer may be a set of features with a size of 136×76 consisting of 128 channels, and the L1 layer may be a set of features with a size of 68×38 consisting of 256 channels.

As in the examples shown in FIGS. 4 and 5, resolutions of each of the layers constituting the multi-level feature group may be different from each other, while the number of channels constituting each of the layers may be the same.

The feature reduction unit (110) may include a feature fusion unit (112) and a channel reduction unit (114).

The feature fusion unit (112) may reduce the number of layers by fusion of a multi-level feature group into a single-level feature group. That is, by performing feature fusion on an input multi-level feature group, a single-level feature group with multiple channels may be generated.

The channel reduction unit (114) may reduce the number of channels of the fused feature (i.e., the single-level feature group). That is, by performing channel reduction on a single-level feature group, a feature group with reduced channels may be generated. Meanwhile, the number of channels of the feature group on which channel reduction is performed may be equal to or less than the number of channels of a single-level feature group. Here, the single-level means that a number of layer is 1.

Whether or not to perform the channel reduction process may be optional. Accordingly, the final data output from the feature reduction unit (110) may be a single-level feature group generated through feature fusion.

A feature conversion unit (120) converts the data output from the channel reduction unit (114) into a format suitable for encoding. For example, the feature transformation unit (120) may perform feature packing and feature quantization.

The feature conversion unit (120) may include a feature packing unit (122) and a feature quantization unit (124).

A feature map may be generated by packing data output from the feature reduction unit (110) (i.e., a feature group with reduced channels or a single-level feature group) into a single frame. That is, through feature packing, input data of 3 dimensions (i.e., channel, width, and height dimensions) may be converted into a feature map of 2 dimensions (i.e., width and height dimensions) with a single channel. Meanwhile, when packing features into a single frame, a feature may be rotated or flipped.

Feature quantization may be based on linear quantization using minimum and maximum values in the feature map. Accordingly, in order to perform dequantization in a feature decoder (200), the minimum and maximum values in the feature map may be encoded as metadata and transmitted. According to feature quantization, data with 32-bit floating point may be transformed into data with 10-bit integer.

The feature encoding unit (130) encodes the quantized feature map. Encoding of the feature map may be based on a general codec technology such as VVC, HEVC, or AV1, or may be based on a codec technology based on a neural network.

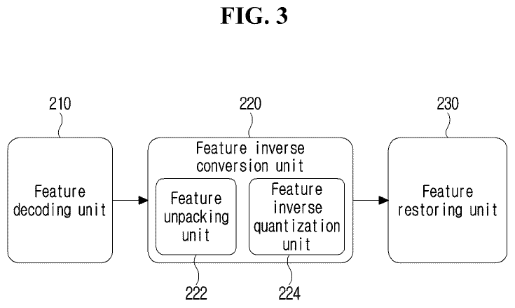

FIG. 3 is a detailed configuration diagram of the feature decoder illustrated in FIG. 1.

Referring to FIG. 3, the feature decoder (200) may include a feature decoding unit (210), a feature inverse conversion unit (220), and a feature restoration unit (230).

The feature decoding unit (210) decodes an encoded feature map. Decoding of the feature map may be based on a general codec technology such as VVC, HEVC, or AV1, or may be based on a codec technology based on a neural network.

The feature inverse conversion unit (220) may include a feature inverse quantization unit (224) and a feature unpacking unit (222).

The feature inverse quantization unit (224) performs inverse quantization on a decoded feature map. Specifically, inverse quantization on a decoded feature map may be performed based on minimum and maximum values in the feature map received from the feature encoder (100).

The feature unpacking unit (222) unpacks a feature map with a single-channel to generate feature data having three dimensions with multiple channels (e.g., a single-level feature group). If a feature is packed into a feature map in a rotated or flipped state, the feature may be rotated or flipped in the opposite direction to generate a single-level feature group.

The feature restoration unit (230) may restore a multi-level feature group from a single-level feature group according to a machine task to be performed.

Meanwhile, each functional unit (i.e., module) illustrated in FIGS. 2 and 3 may be implemented by a neural network, or may be implemented based on at least one of hardware and software. Meanwhile, the input/output data of each unit (i.e., module) may have a form of input/output data of a neural network.

Meanwhile, to improve performance of feature map compression, PCA (Picture Component Analysis) transform may be applied. Through PCA transform, the dimensionality of the input data set may be reduced, thereby increasing feature map encoding/decoding efficiency.

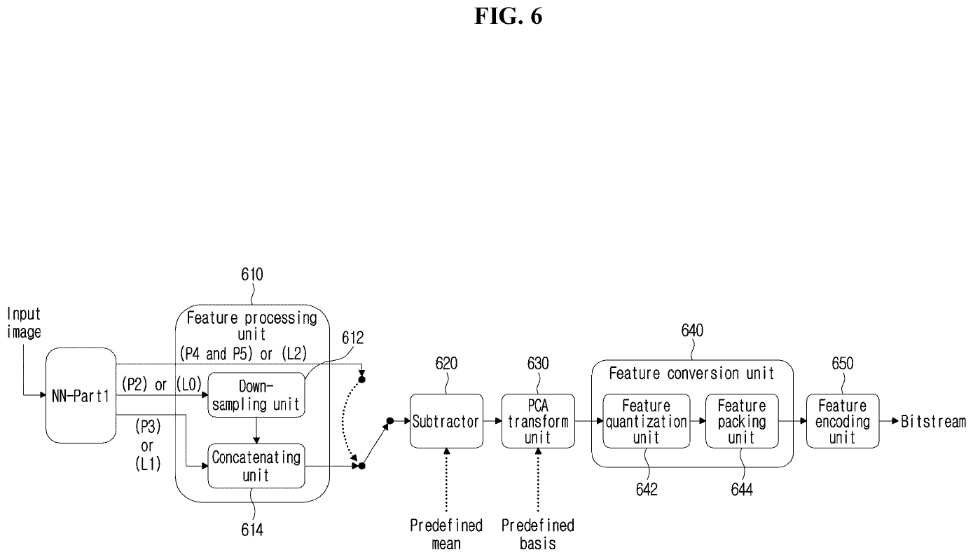

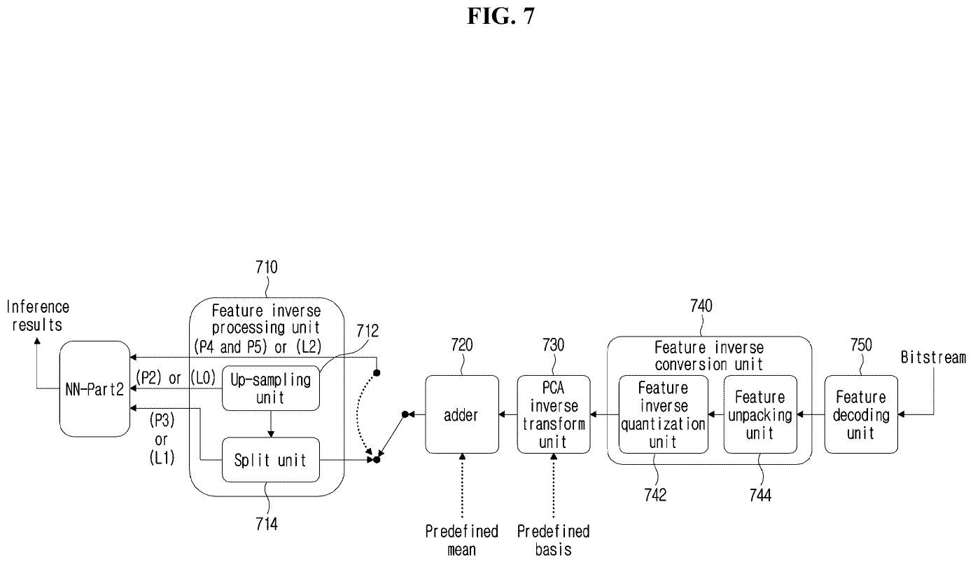

FIGS. 6 and 7 are diagrams showing a configuration of a feature encoder and a feature decoder to which PCA transform/inverse transform is applied, respectively. For convenience of explanation, it is assumed that the multi-level feature group includes P2 to P5 layers or L0 to L2 layers.

As in the example illustrated in FIG. 6, a feature encoder for PCA transform may include a feature processing unit (610), a subtractor (620), a PCA transform unit (630), a feature conversion unit (640), and a feature encoding unit (650).

The feature processing unit (610) in the feature encoder may include a down-sampling unit (612) and a concatenating unit (614).

In the down-sampling unit (612), the amount of feature data may be reduced through down-sampling. Specifically, by performing down-sampling on the P2 layer/L0 layer, which a size (i.e., width×height) of each feature is the largest, the size of the P2 layer/L0 layer may be reduced. Through down-sampling, the size of the P2 layer/L0 layer may be reduced by four times.

In the concatenating unit (614), the down sampled P2 layer/L0 layer may be concatenated to the P3 layer/L1 layer to generate a concatenated feature layer.

Meanwhile, in the example illustrated in FIG. 6, the P4 and P5 layers/L2 layer, which a size of each feature is relatively small, are exemplified as being input to the subtractor (620) without any processing being performed.

In the subtractor (620), subtraction is performed on the input feature layer. Here, the subtraction may be subtracting a predefined mean value for each of the input feature layers.

For example, the subtractor (620) may subtract a predefined mean value from each of the pixels in the concatenated layer (i.e., the result of concatenating the down-sampled P2 layer/L0 layer and the P3 layer/L1 layer), the P4 and P5 layers/L2 layer. By subtracting the predefined mean value for each layer, the amount of data expressing the feature may be reduced.

Meanwhile, the mean value may be individually determined for each of the input layers. In addition, information indicating the predefined mean value may be encoded and signaled in order to restore the feature layer in the feature decoder based on the predefined mean value.

In the PCA transform unit (630) of the feature encoder, PCA transform is performed for each of the input feature layers. Specifically, the PCA transform unit may perform PCA transform for each of the concatenated layers, P4 and P5 layers/L2 layers.

Meanwhile, the PCA transform for each of the layers may be performed using a predefined basis vector corresponding to the layer. The predefined basis vector may be obtained in advance from a sample data set. Meanwhile, the basis vector may also be referred to as a transformation matrix.

In the feature decoder, in order to perform PCA inverse transform based on the predefined basis vector, information indicating the coefficients of the basis vector may be encoded and signaled.

The feature conversion unit (640) may include a feature quantization unit (642) and a feature packing unit (644). The feature quantization unit (642) may quantize the transformation coefficients generated as a result of the PCA transform. Quantization of the transform coefficients may be based on linear quantization based on maximum and minimum values among the transform coefficients. Information indicating the maximum and minimum values among the transform coefficients may be encoded and signaled to perform inverse quantization in the feature decoder.

The feature packing unit (644) may pack the quantized transform coefficients into one frame. Through this, one frame in which the quantized transform coefficients are packed may be generated.

The feature encoding unit (650) encodes the frame generated through the feature conversion unit. The encoding of the frame may be based on a general codec technology such as VVC, HEVC, or AV1, or may be based on a codec technology based on a neural network.

As in the example illustrated in FIG. 7, the feature decoder for PCA inverse transform may include a feature decoding unit (750), a feature inverse conversion unit (740), a PCA inverse transform unit (730), an adder (720), and a feature inverse processing unit (710).

The feature decoding unit (750) decodes an encoded frame. The decoding of the frame may be based on a general codec technology such as VVC, HEVC, or AV1, or may be based on a codec technology based on a neural network.

The feature inverse conversion unit (740) may include a feature unpacking unit (744) and a feature inverse quantization unit (742). The feature unpacking unit (744) unpacks coefficients included in decoded frames into a plurality of layers. The feature inverse quantization unit (742) may perform inverse quantization on each of the plurality of layers generated by the unpacking.

The PCA inverse transform unit (730) in the feature decoder may perform PCA inverse transform on the feature layers output through the feature conversion unit (740). Here, the PCA inverse transform for each of the feature layers may be performed using a predefined basis vector corresponding to the feature layer.

In the adder (720), a predefined mean value may be added to the feature layers output through the PCA inverse transform unit.

Meanwhile, the feature inverse processing unit (710) may include a split unit (714) and an up-sampling unit (712).

In the split unit (714), a split may be performed on a concatenated feature layer among the feature layers to which a predefined mean value is added. For example, the concatenated layer may be split into a P3 layer/L1 layer and a down-sampled P2 layer/down-sampled L0 layer through the split.

In the up-sampling unit (712), up-sampling may be performed on the down-sampled P2 layer/down-sampled L0 layer.

According to the process, the feature decoder may restore a multi-level feature group including the P2 to P5 layers/L0 to L2 layers.

Meanwhile, in the example illustrated in FIG. 6, down-sampling is exemplified for the P2 layer/L0 layer. At this time, since the P2 layer/L0 layer includes information on relatively small objects, if the P2 layer/L0 layer is down-sampled, the search performance for the small objects may decrease.

In order to solve the above problem, the present disclosure proposes a method of performing feature map encoding using data of all layers.

In addition, in the examples illustrated in FIG. 6 and FIG. 7, PCA transform/PCA inverse transform is performed for each of the layers. However, when performing PCA transform/PCA inverse transform is performed for each layer, there is a problem that duplicate data between layers is not removed.

To solve the above problem, the present disclosure proposes a method of merging all layers into a single feature map and then performing PCA transform on the merged feature map.

Hereinafter, the detailed configuration of the feature encoder and feature decoder proposed in the present disclosure will be described in detail.

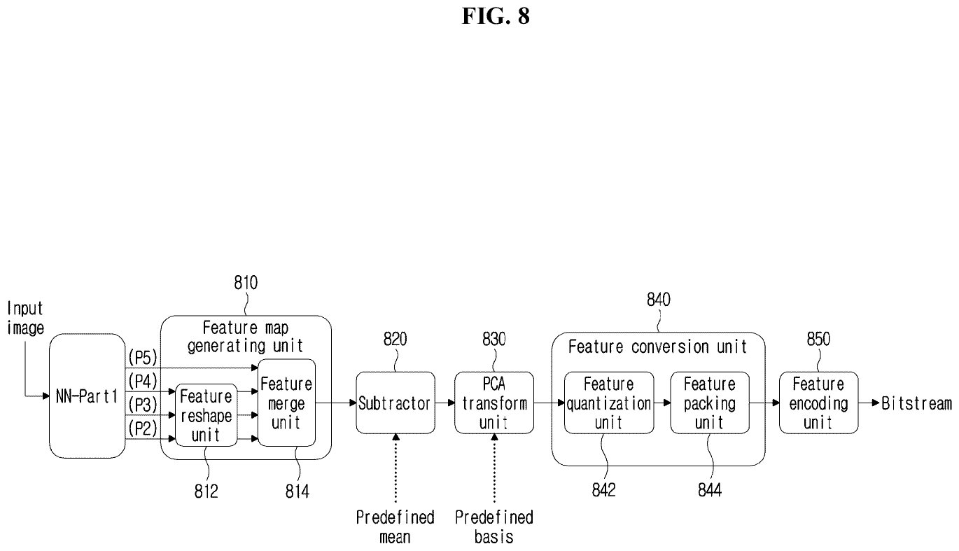

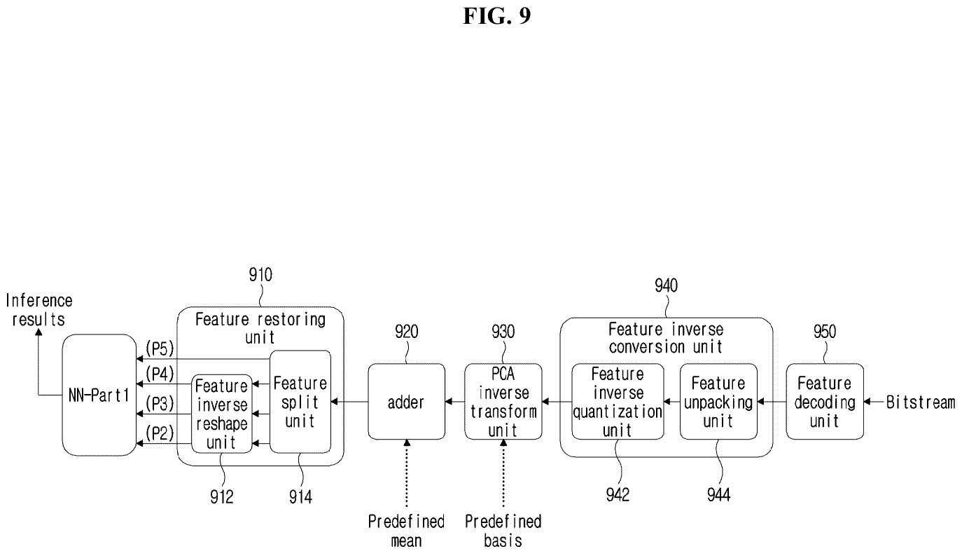

FIGS. 8 and 9 are block diagrams of the feature encoder and feature decoder according to one embodiment of the present disclosure.

Let's assumed that the multi-level feature group includes P2 to P5 layers generated through Faster/Mask R-CNN, as in the example illustrated in FIG. 4, or L0 to L2 layers generated through the JDE network.

Referring to FIG. 8, the feature encoder may include a feature map generating unit (810), a subtractor (820), a PCA transform unit (830), a feature conversion unit (840), and a feature encoding unit (850). Meanwhile, the feature conversion unit (840) and the feature encoding unit (850) have been described in detail with reference to FIG. 6, so a detailed description thereof will be omitted.

The feature map generating unit (810) merges multiple layers to generate a single feature map. To this end, the feature map generating unit (810) may include a feature reshape unit (812) and a feature merge unit (814).

The feature reshape unit (812) performs rearrangement of input feature layers. The feature rearrangement may be based on a pixel un-shuffling technique.

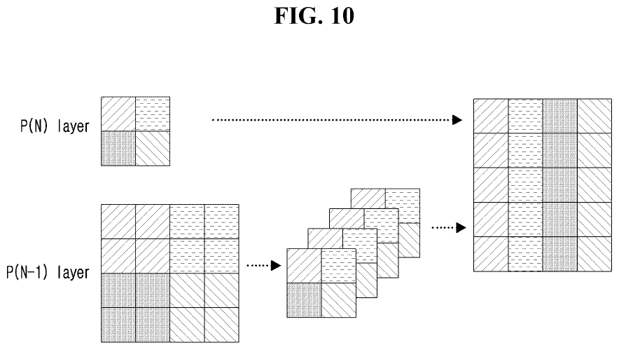

FIG. 10 illustrates an example of rearranging features using a pixel un-shuffling technique.

In the case of the P2 to P5 layers, each of the width and height of the P(N−1) layer is twice that of the PN layer. Accordingly, four pixel locations in the P(N−1) layer are corresponding to one pixel location in the PN layer.

For example, in the example illustrated in FIG. 10, pixels included in the 2×2-sized areas at the top-left of the P2 layer may be corresponding pixels of a pixel at the top-left of the P3 layer.

Using this correspondence between pixels, the P(N−1) layer may be divided into multiple channels (i.e., four channels) having the same size as the PN layer. Meanwhile, each channel of the P(N−1) layer may be generated by sub-sampling different locations. For example, four channels generated from the P(N−1) layer may be obtained by sub-sampling the locations (2x, 2y), (2x+1, 2y), (2x, 2y+1), (2x+1, 2y+1), respectively.

After performing pixel un-shuffling, the layers may be merged to generate 2D data (i.e., a single feature map) for performing PCA transform. For example, as in the example illustrated in FIG. 10, the collocated pixels located in the same space may be arranged according to a predetermined manner to generate a feature map. In the example illustrated in FIG. 10, the collocated pixels are arranged in one column.

Since the collocated pixels are arranged in one column, the pixels belonging to the same column may have a high possibility of being mutually redundant data.

Meanwhile, unlike the illustrated example, the collocated pixels may be arranged in one row, or the collocated pixels may be arranged within an area of a predefined size. In this case, the area having the predefined size may have a square shape, a triangular shape, or a polygonal shape, depending on the number of the collocated pixels.

Meanwhile, arranging the collocated pixels in one column may be based on at least one of a channel-based arrangement method or a resolution-based arrangement method.

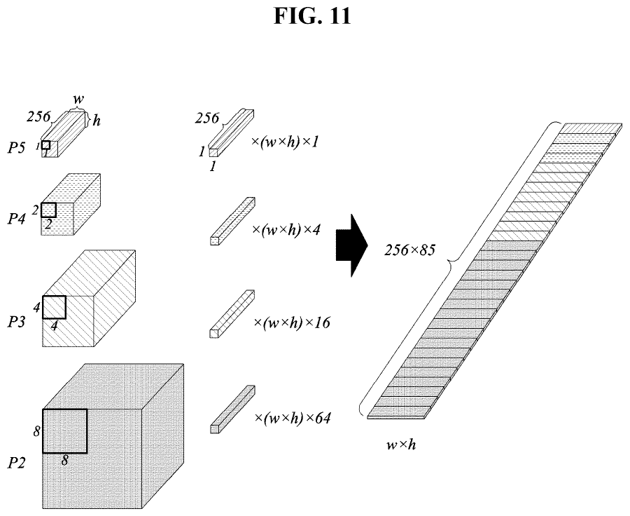

FIG. 11 illustrates an arrangement method based on the number of channels.

As described above, the number of channels of the P2 to P5 layers is the same as 256. By utilizing this, feature reshape may be performed to configure the same location samples in the multiple channels constituting the layer into a single column. That is, each of the P2 to P5 layers may be divided into multiple base units each of which is (1×256) size.

For example, if the resolution of the P5 layer with the smallest resolution is (w×h), the P5 layer may be divided into base units as many as (w×h).

In addition, since the P4 layer has twice the width and height of the P5 layer, the P4 layer may be divided into base units as many as (2w×2h).

Afterwards, the base unit of each layer generated through feature reshape may be merged into a 2D image to generate a single feature map.

Specifically, based on the P5 layer with the smallest resolution, (w×h) base units may be arranged in a row and the arranged base units may set as one tile in the feature map.

Since the P4 layer has four times the number of unit areas compared to the P5 layer, four tiles may be generated by arranging the base units in the P4 area in a row.

That is, four pixels in the P4 layer corresponding to the pixel at the (x, y) position in the P5 layer may be arranged at the (x, y) position in four tiles, respectively.

In addition, the height of each tile may be set to be the same as the number of channels in each feature layer.

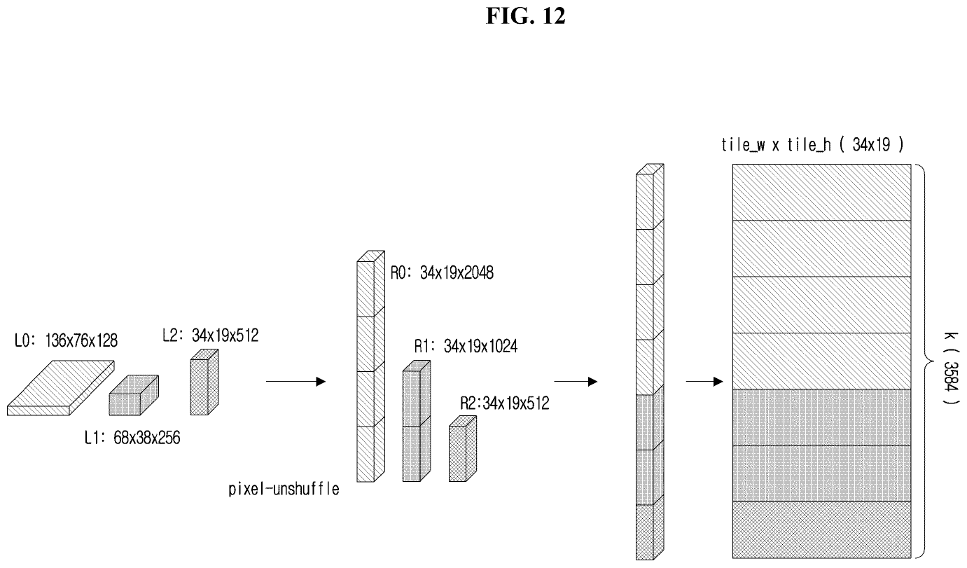

FIG. 12 illustrates an example of a resolution-based arrangement method.

In FIG. 12, it is illustrated that the multi-level feature group includes L0 to L2 layers.

As in the example illustrated in FIG. 12, the number of channels in the modified L1 layer (i.e., R1 layer) may be 16 times that of the original L1 layer by converting the size of the L1 layer based on the size of the L2 layer.

In addition, the number of channels in the modified L0 layer (i.e., R0 layer) may be 16 times that of the original L0 layer by converting the size of the L0 layer based on the size of the L2 layer.

Afterwards, the modified layers may be merged into one to generate a single feature map, and each channel may be set as an independent tile in the feature map.

That is, as in the example illustrated in FIG. 12, a feature map may be generated by reshaping the layers based on the feature with the lowest resolution (i.e., the width (w)×height (h) of the P5 layer), and then setting each channel of the reshaped layers as one tile.

Or, as in the example illustrated in FIG. 12, a feature may be generated by performing picture un-shuffling based on the feature with the lowest resolution (i.e., the width×height of the L2 layer), and then setting each channel of the unshuffled layers (i.e., the R0, R1, and R2 layers) as one tile.

Accordingly, the number of tiles included in the feature map may be equal to the sum of the number of channels of the layers on which picture un-shuffling is performed.

The merged feature map generated in the feature map generating unit (810) is input to the subtractor (820), and the subtractor (820) may subtract a predefined mean value from the merged feature map. Specifically, the predefined mean value may be subtracted from each pixel constituting the merged feature map.

The PCA transform unit (830) may perform PCA transform on the feature map output from the subtractor (820). As described above, the PCA transform may be performed by a predefined basis vector shared between the feature encoder and the feature decoder.

Meanwhile, the PCA transform may be performed on all features in the feature map at the same time. By performing the PCA transform on all features at the same time, the redundancy between layers may be removed through the PCA transform.

The PCA transform may be performed by a predefined basis vector. At this time, PCA transform may be performed using the reduced basis vector to reduce the amount of data to be encoded/decoded.

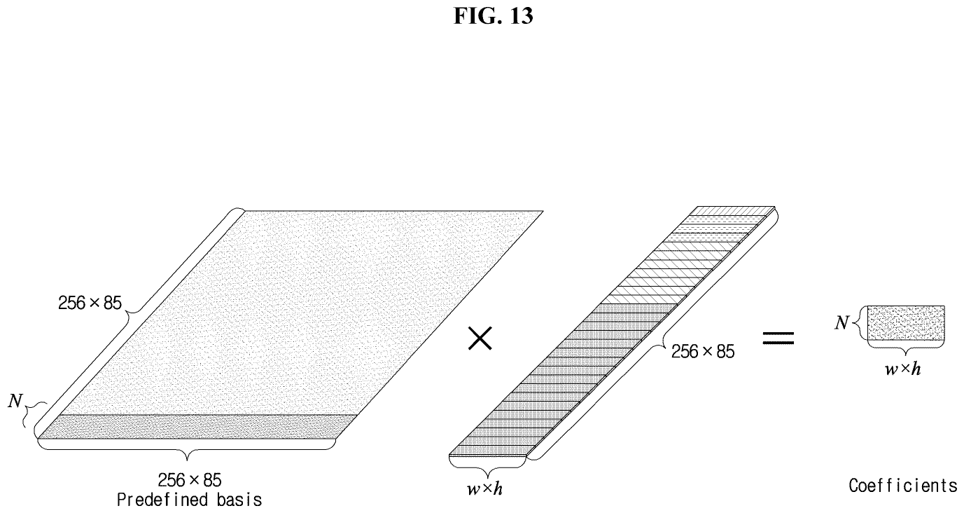

FIG. 13 shows an example of performing PCA transform using reduced basis vectors.

For example, when performing PCA transform on a feature map of size ((w×h)×(256×85)), PCA transform may be performed using basis vectors of size N×(256×85) (or (256×85)×N) instead of basis vectors of size (256×85)×(256×85). Here, N may have a value smaller than the height of the feature map.

Accordingly, transform coefficients generated through PCA transform may have a size of N×(w×h) (or (w×h)×N). As a result, the number of transform coefficients generated through PCA transform (N×(w×h)) may be smaller than the size of the feature map ((w×h)×(256×85)). Meanwhile, the variable N, which represents the size of the reduced basis vector, may be predefined in the feature encoder and feature decoder.

Alternatively, the information indicating the variable N may be explicitly encoded and signaled.

Alternatively, the variable N may be adaptively determined according to the size of the merged feature map.

Referring to FIG. 9, the feature decoder may include a feature decoding unit (950), a feature inverse conversion unit (940), a PCA inverse transform unit (930), an adder (920), and a feature restoring unit (910). Meanwhile, since the feature inverse conversion unit (940) and the feature decoding unit (950) have been described in detail with reference to FIG. 7, a detailed description thereof will be omitted.

The PCA inverse transform unit (930) performs PCA inverse transform on the coefficients output through the feature inverse conversion unit. The PCA inverse transform may be performed based on a basis vector.

Meanwhile, when a reduced basis vector is used in the feature encoder, the feature decoder may also perform PCA inverse transform using an asymmetrical basis vector (e.g., N×(256×85) (or, (256×85)×N)). When an asymmetrical basis vector is used, the size of the feature map may be larger than the number of transform coefficients input to the PCA inverse transform unit (930). The feature map output from the PCA inverse transform unit (930) is input to the adder (920), and the adder (920) may add a predefined mean value to the feature map. Specifically, a predefined mean value may be added to each pixel constituting the merged feature map.

The feature restoring unit (910) splits the feature map output from the adder (920) to generate multiple layers. To this end, the feature restoring unit (910), the feature split unit (914), and the feature inverse reshape unit (912) may be included.

The feature split unit (914) splits the feature map into multiple channels. For example, the feature split unit (914) may split pixels belonging to the same row in a tile into one channel.

Thereafter, the feature inverse reshape unit (912) may merge the multiple channels output through the feature split unit (914) through pixel shuffling to restore the feature layer.

For example, the feature inverse reshape unit (912) may restore one channel by arranging pixels belonging to a row of ((w×h)×1) size within a tile to (w×h), and may restore a feature layer by combining channels extracted from tiles corresponding to each layer (see FIG. 11).

Meanwhile, in merging channels with same positions extracted from multiple tiles, multiple collocated pixels may be arranged in a predefined area according to a pixel shuffling technique. (see FIG. 10).

Alternatively, the feature inverse reshape unit (912) may restore a feature layer by combining multiple channels and then adjusting the resolution and the number of channels (see FIG. 12).

Adjusting the resolution and the number of channels may represent arranging multiple collocated pixels into a predefined area according to a pixel shuffling technique (see FIG. 10).

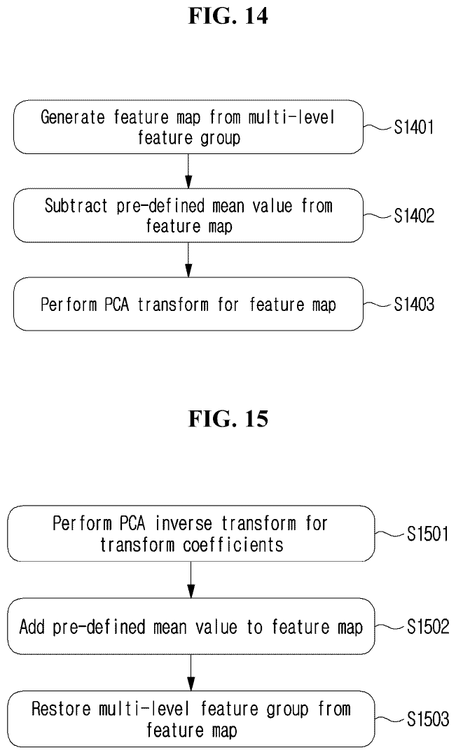

FIGS. 14 and 15 are flowcharts of a feature map encoding method and a feature map decoding method according to an embodiment of the present disclosure, respectively.

Referring to FIG. 14, firstly, a feature map may be generated through reshape and feature merging of a multi-level feature group (S1401). At this time, the multi-level feature group may be composed of multiple layers, and the reshape may be performed through pixel un-shuffling. In addition, a feature map may be generated by merging multiple base units obtained through pixel shuffling. At this time, the base units may be calculated based on the number of channels (see FIG. 12) or may be calculated based on the smallest resolution (see FIG. 13).

A predefined mean value is subtracted from the generated feature map (S1402).

Thereafter, PCA transform may be performed on the subtracted feature map to generate transform coefficients (S1403). At this time, PCA transform may also be performed using the reduced basis vector.

Referring to FIG. 15, firstly, PCA inverse transform may be performed on the transform coefficients (S1501). At this time, PCA inverse transform may also be performed using the reduced basis vector.

A predefined mean value is added to the feature map generated through PCT inverse transform (S1502).

Thereafter, a multi-level feature group may be restored through feature split and inverse reshape for the feature map to which the predefined mean value is added (S1503). Specifically, a feature map may be split into multiple channels, and a feature layer may be generated by merging the multiple channels through pixel shuffling.

Meanwhile, in the above-described embodiments, the operations of the subtractor and adder for subtracting and adding the mean value, respectively, are not essential for implementing the embodiments according to the present disclosure. In other words, omitting the corresponding components may also be included in the embodiments of the present disclosure.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed is:

1. A method of encoding a feature map, the method comprising:
generating a feature map from a multi-level feature group; and
performing PCA (Picture Component Analysis) transform for the feature map,
wherein, generating the feature map comprises:
reshaping the multi-level feature group; and
generating the feature map by merging a plurality of base units generated by the reshape.

2. The method of claim 1, wherein the reshape is based on pixel un-shuffling technique.

3. The method of claim 2, wherein a first layer in the multi-level feature group is reshaped to a resolution of a second layer in the multi-level feature group.

4. The method of claim 3, wherein the second layer has a smallest resolution in the multi-level feature group.

5. The method of claim 4, wherein in response to a resolution of the first layer is N times to the resolution of the second layer, a number of channel of a reshaped first layer is N times to a number of channel of the first layer.

6. The method of claim 5, wherein the second layer is arranged in a single tile in the feature map, and
wherein the first layer is arranged in N tiles in the feature map.

7. The method of claim 6, wherein N pixels, in the first layer, which corresponding to a pixel at a first position in the second layer are arranged in a same column as the pixel at the first position in the feature map.

8. The method of claim 2, wherein a first layer and a second layer in the multi-level feature group have a same number of channels but have different resolution, and
wherein each of the first layer and the second layer are reshaped by the number of channels.

9. The method of claim 1, wherein the PCA transform is performed based on a reduced basis vector, and
wherein a number of transform coefficients generated by the PCA transform is less than a size of the feature map.

10. A method of decoding a feature map, the method comprising:
performing PCA (Picture Component Analysis) inverse transform for transform coefficients; and
restoring a multi-level feature group from a feature map output by the PCA inverse transform,
wherein restoring the multi-level feature group comprises:
splitting the feature map into a plurality of channels; and
restoring the multi-level feature group by merging base units per a feature layer.

11. The method of claim 10, wherein each of the plurality of channels is obtained by arranging pixels in a single row in the feature map in a pre-defined size.

12. The method of claim 10, wherein a feature layer in the multi-level feature group is restored by merging a plurality of channels obtained from at least one tile, in the feature map, corresponding to the feature layer.

13. The method claim 12, wherein in response to a number of tiles corresponding to the feature layer is plural, the feature layer is restored by arranging each of the plurality of channels into a pre-defined position according to pixel shuffling technique.

14. The method of claim 10, wherein a size of a tile in the feature map is determined based on a size of a feature layer with the smallest resolution in the multi-level feature group.

15. The method of claim 10, wherein in response to a number of channels is the same between a first layer and a second layer in the multi-level feature group, a size of the tile in the feature map is determined based on the number of channels.

16. The method of claim 15, wherein in response to a resolution of the first layer is N times to a resolution of the second layer, a number of tiles corresponding to the first layer is N times to a number of tiles corresponding to the second layer.

17. The method of claim 10, wherein the PCA inverse transform is performed by a reduced basis vector, and
wherein a size of the feature map generated by the PCA inverse transform is greater than a number of the transform coefficients.

18. A non-transitory computer readable medium storing instructions for executing a feature map encoding method, the method comprising:
generating a feature map from a multi-level feature group; and
performing PCA (Picture Component Analysis) transform for the feature map,
wherein, generating the feature map comprises:
reshaping the multi-level feature group; and
generating the feature map by merging a plurality of base units generated by the reshape.
